(19) United States
(12) Patent Application Publication
(10) Pub. No.: US 2021/0354670 A1
(43) Pub. Date: Nov. 18, 2021

(54) HYDRAULIC BLOCK FOR A HYDRAULIC MODULATOR OF A VEHICLE HYDRAULIC-POWER BRAKE SYSTEM

(71) Applicant: Robert Bosch GmbH, Stuttgart (DE)

(72) Inventor: Matthias Greiner, Simmozheim (DE)

(21) Appl. No.: 17/209,829

(22) Filed: Mar. 23, 2021

(30) Foreign Application Priority Data
May 12, 2020 (DE) 102020205950.0

(51) Int. Cl. B60T 8/36; B60T 8/40

(52) U.S. Cl. CPC B60T 8/368; B60T 8/4081; B60Y 2400/81; B60Y 2400/306; B60Y 2400/301

(57) ABSTRACT

For a compact design of a hydraulic block of a hydraulic modulator of a vehicle slip-controlled hydraulic-power brake system, an electric motor of a power brake-pressure generator is disposed on the same side of the hydraulic block as solenoid valves for a brake-pressure control and an electronic control unit for controlling the electric motor and the solenoid valves.

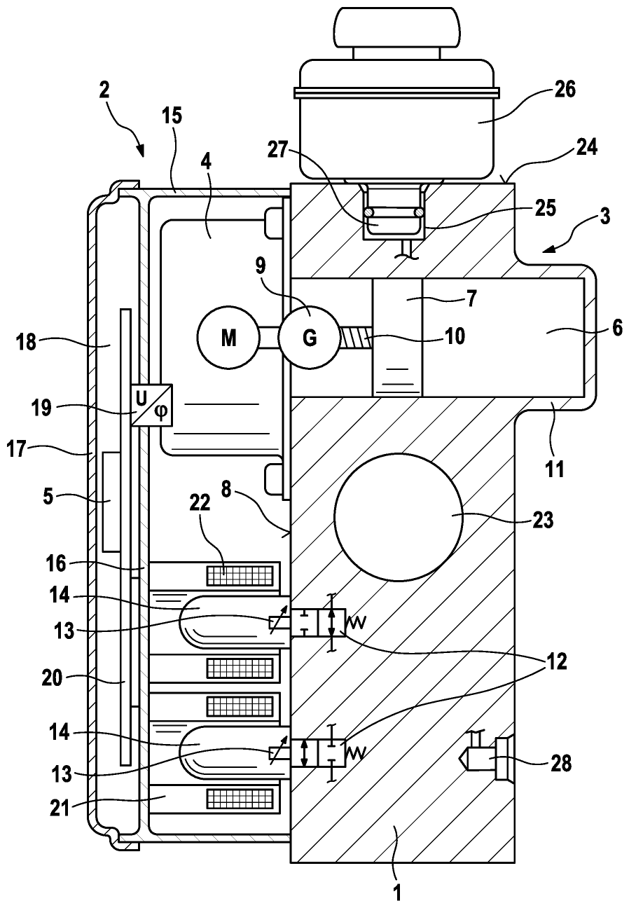

### CROSS REFERENCE

The present application claims the benefit under 35 U.S.C. § 119 of German Patent Application No. DE 102020205950.0 filed on May 12, 2020, which is expressly incorporated herein by reference in its entirety.

### FIELD

The present invention relates to a hydraulic block for a hydraulic modulator of a vehicle hydraulic-power brake system.

### BACKGROUND INFORMATION

German Patent Application No. 10 2016 202 113 A1 describes a cuboidal hydraulic block for a hydraulic modulator of a vehicle slip-controlled hydraulic-power brake system, in which a brake master cylinder bore is placed traversing from one to an opposite narrow side, and a power cylinder bore is placed perpendicular to the brake master cylinder bore, likewise passing through two opposite large sides of the hydraulic block. Coaxial to the power cylinder bore, an electric motor is mounted on one of the two large sides of the hydraulic block. Disposed on the other opposite large side of the hydraulic block is a box-shaped control-unit housing having an electronic control unit and solenoid coils for solenoid valves. The solenoid coils are situated inside the control-unit housing in such a way that they surround valve domes of solenoid valves projecting from the hydraulic block, which are located on the same side of the hydraulic block as the control unit.

### SUMMARY

In accordance with an example embodiment of the present invention an electric motor for displacing a power piston in a power cylinder bore of a hydraulic block in order to generate hydraulic brake pressure with non-muscular energy, is disposed on the same side of the hydraulic block as an electronic control unit and solenoid valves for controlling the brake pressure, control also to be understood here as an open-loop control.

The example hydraulic block of the present invention is provided for a hydraulic modulator of a vehicle hydraulic-power brake system that, in particular, has a slip control. The principal part of vehicle hydraulic-power brake systems which have a slip control is a hydraulic modulator having a hydraulic block, to which hydraulic wheel brakes of the vehicle brake system are connected via brake lines. Specifically, slip controls include an antilock braking system, traction control system and/or vehicle dynamics control/electronic stability program, for which the abbreviations ABS, TCS and/or VDC/ESP are customary. The latter are also commonly referred to as “anti-skid control systems.” Slip controls are familiar and are not explained in greater detail here. The hydraulic modulator is used to generate brake pressure with non-muscular energy and to control brake pressure.

The hydraulic block is used for the mechanical securing and hydraulic interconnection of hydraulic components of the vehicle brake system and its slip control, respectively. Such hydraulic components are, inter alia, solenoid valves, non-return valves, hydraulic accumulators, damping chambers, pressure sensors and a power brake-pressure generator, the power brake-pressure generator usually having a piston/cylinder unit which is or becomes accommodated in a power cylinder bore of the hydraulic block. A power piston of the piston/cylinder unit of the power brake-pressure generator is often also referred to as a plunger piston, and the power cylinder bore as a plunger receiver, plunger bore, plunger cylinder or the like. In order to generate pressure using non-muscular energy, the power piston of the power brake-pressure generator is displaced electromechanically in the cylinder or in the power cylinder bore with the aid of the electric motor—which is mounted on the outside of the hydraulic block—via a screw drive or in general a rotation/translation transformation gear; a mechanical reduction gear, particularly a planetary gear, may be disposed between the electric motor and the screw drive or the transformation gear. The power cylinder bore in the hydraulic block may form the cylinder of the power brake-pressure generator, or a cylinder, a cylinder sleeve or the like may be disposed on or in the power cylinder bore. The power cylinder bore may also be regarded as mounting for the piston or the piston/cylinder unit of the power brake-pressure generator.

The hydraulic components are secured in mountings in the hydraulic block, which usually take the form of cylindrical through holes or blind holes, in part with steppings in diameter. “Interconnected” means that the mountings, or rather the hydraulic components secured in them, are connected by lines in the hydraulic block according to a hydraulic connection diagram of the vehicle brake system and/or its slip control. The lines are typically drilled in the hydraulic block.

Fitted with the hydraulic components of the vehicle brake system and its slip control, the hydraulic block forms a hydraulic modulator, “fitted” meaning that the hydraulic components are fixed in the mountings of the hydraulic block provided in each case for them.

In particular, the hydraulic block according to an example embodiment of the present invention is cuboidal and preferably Cartesian-drilled, especially being made of metal. “Cartesian-drilled” means that the mountings for the hydraulic components and the lines connecting them are placed in the hydraulic block so that they are parallel and perpendicular to each other and to surfaces and edges of the hydraulic block. Individual oblique mountings and/or lines are possible.

The hydraulic block of the present invention has an electronic control unit for closed-loop or open-loop control of the hydraulic brake pressure in a power braking and/or slip control, the electronic control unit, among other things, controlling the solenoid valves and the electric motor in closed or open loop. According to the present invention, the electronic control unit, the electric motor of the power brake-pressure generator and mountings for the solenoid valves are located on the same side of the hydraulic block, which is referred to here as first side of the hydraulic block. As a result, valve domes of the solenoid valves, in which armatures of the solenoid valves are accommodated, project from the first side of the hydraulic block, on which the electric motor and the electronic control unit are also situated.

One advantage of the example embodiment of the present invention is that the electric motor and the solenoid valves, that is, their valve domes project from the same side of the hydraulic block, and the electronic control unit is also disposed on this side, which permits a compact design of the hydraulic block, or more specifically, of a hydraulic modulator having the hydraulic block, and which may be a safety advantage in the event of an accident, because the hydraulic block, or rather the hydraulic modulator may be accommodated more simply in an engine compartment of a motor vehicle, so that a combustion engine of the motor vehicle probably will not collide with the electric motor of the hydraulic block if the combustion engine shifts in the engine compartment owing to the accident.

Further advantages of the present invention may include that a power cylinder on a side of the hydraulic block opposite the electric motor may be lengthened as desired per se, because the control unit is not in the way there, and that an angle-of-rotation sensor for the electric motor may be disposed on the control unit and does not have to be contacted through the hydraulic block. Likewise, the electric motor itself does not have to be contacted through the hydraulic block.

Further developments and advantageous refinements of the present invention are disclosed herein.

All features disclosed in the specification and the figure may be realized individually or in basically any combination in specific embodiments of the present invention. Realizations of the present invention which do not have all, but rather only one or more features of a specific embodiment of the present invention, are possible.

### BRIEF DESCRIPTION OF THE DRAWING

The present invention is explained in greater detail below on the basis of a specific embodiment shown in the figure.

The FIGURE shows a simplified schematic representation of a hydraulic block according to an example embodiment of the present invention.

### DETAILED DESCRIPTION OF EXAMPLE EMBODIMENTS

Hydraulic block 1 according to an example embodiment of the present invention shown in the figure is provided for a hydraulic modulator 2 of a vehicle hydraulic-power brake system (otherwise not shown) having a slip control. Namely, slip controls are antilock braking systems, traction control systems and/or vehicle dynamics controls/electronic stability programs, for which the abbreviations ABS, TCS and/or VDC/ESP are customary. Vehicle hydraulic-power brake systems with slip control and their hydraulic connection diagrams are familiar and are not explained here.

In the exemplary embodiment, hydraulic block 1 is a narrow cuboidal metal block whose mutually opposite large sides are almost quadratic. “Narrow” means that a distance between the two large sides is not greater than one half a length or width of the large sides. In the exemplary embodiment, the distance of the two large sides from each other is approximately one third to one fourth the length or width of the large sides. Other geometric ratios are possible. The form of hydraulic block 1 described is not imperative for the present invention.

Hydraulic block 1 is used for the mechanical fixing and hydraulic interconnection of hydraulic components of a brake-pressure generation using non-muscular energy and a brake-pressure control during a power braking and/or a slip control. In particular, such hydraulic components are solenoid valves, non-return valves, hydraulic accumulators, hydraulic pumps, a power brake-pressure generator 3 and a pedal-travel simulator. The hydraulic components are secured in mountings in hydraulic block 1. The mountings are cylindrical counterbores, blind holes and/or through holes which may have steps in diameter and into which the hydraulic components are introduced and are or become secured in pressure-tight fashion, e.g., by a circumferential caulking. The hydraulic components may be sunk in the mountings or may project from hydraulic block 1. Fitted with the hydraulic components, an electric motor of power brake-pressure generator 3 and an electronic control unit 5, hydraulic block 1 forms hydraulic modulator 2 for generating power brake pressure and for controlling brake pressure of the vehicle power-brake system.

Hydraulic interconnection means that the mountings for the hydraulic components are connected to each other by lines which run through hydraulic block 1, according to a hydraulic connection diagram of the vehicle power-brake system and its slip control. The mountings and lines form a so-called “drilling” of hydraulic block 1, in principle the mountings and lines also being able to be produced other than by drilling.

Hydraulic block 1 according to the present invention has a power cylinder bore 6 which goes through hydraulic block 1 in a direction perpendicular to the two opposite large sides of hydraulic block 1. Power cylinder bore 6 may be drilled or produced other than by drilling. Power cylinder bore 6 forms a cylinder of a piston/cylinder unit of power brake-pressure generator 3 and is used for displaceable accommodation of a power piston 7 of power brake-pressure generator 3, which is also often referred to as plunger piston. Power piston 7 may be supported, in a manner allowing axial displacement, directly in power cylinder bore 6 or indirectly in a cylinder sleeve or a cylinder which is disposed in power cylinder bore 6.

Electric motor 4 for the drive, that is, for displacing power piston 7 in power cylinder bore 6, is mounted coaxially with respect to power cylinder bore 6 on the outside of one of the two large sides of hydraulic block 1, denoted here as first side 8 of hydraulic block 1. Electric motor 4 displaces power piston 7 via a planetary gear as reduction gear 9, represented as a graphical symbol, and a recirculating ball screw and nut, which simplified is drawn as screw drive 10. Electric motor 4, reduction gear 9, screw drive 10, power piston 7 and power cylinder bore 6 form power brake-pressure generator 3 for generating a hydraulic brake pressure for a power braking.

In the exemplary embodiment, power cylinder bore 6 is longer than hydraulic block 1 is thick, thickness being denoted here as a distance of the two large sides from each other. To that end, hydraulic block 1 has a cylindrical tube-shaped cylinder extension 11 that is closed at one end, has an identical inside diameter as power cylinder bore 6 and projects coaxially from hydraulic block 1 on the large side opposite first side 8. In the exemplary embodiment, cylinder extension 11 is in one piece with hydraulic block 1, however, for example, a cylinder extension may also be disposed on hydraulic block 1 as a bowl-shaped cylinder head coaxially with respect to power cylinder bore 6 (not shown).

To control the brake pressure, controlling also being understood to be an open-loop control, solenoid valves 12 are disposed on or in first side 8 of hydraulic block 1. Solenoid valves 12, which are drawn as graphical symbols, are situated in blind holes that are placed in first side 8 of hydraulic block 1. The blind holes may have diameter steps and form mountings for solenoid valves 12. For example, solenoid valves 12 are inlet valves and outlet valves of the slip control, and may also be used for controlling brake pressure during a power braking. In general, the brake pressure during a power braking is controlled by the displacement of power piston 7 in power cylinder bore 6.

Electromagnets 13 of solenoid valves 12, which are likewise represented as graphical symbols in the drawing, are located outside of hydraulic block 1 in valve domes 14 that project from first side 8 of hydraulic block 1.

Electronic control unit 5 is likewise situated on first side 8 of hydraulic block 1, on which electric motor 4 of power brake-pressure generator 3 and solenoid valves 12 of the slip control are also located. Electronic control unit 5 has a box-shaped control-unit housing 15, which is disposed with its open side on first side 8 of hydraulic block 1. Control-unit housing 15 forms a kind of lid or cover which covers electric motor 4 and valve domes 14 of solenoid valves 12, so that they are protected from moisture and dirt. Electronic control unit 5 is accommodated on a base, or rather a roof 16 of control-unit housing 15. A lid 17, which is disposed on a side of roof 16 of control-unit housing 15 facing away from hydraulic block 1, encloses a cavity 18 between itself and roof 16 of control-unit housing 15, in which electronic control unit 5 is located.

Electronic control unit 5 controls electric motor 4 of power brake-pressure generator 3 and solenoid valves 12 in closed or open loop in order to control brake pressure during a power braking and/or a slip control.

Electronic control unit 5 has an angle-of-rotation sensor 19 for electric motor 4, with which a rotation and/or an angle of rotation of a rotor of electric motor 4 is able to be measured. In the exemplary embodiment, angle-of-rotation sensor 19 is situated on a mounting plate 20 of electronic control unit 5, on which electronic control unit 5 is also disposed.

First side 8 of hydraulic block 1, on which electric motor 4 of power brake-pressure generator 3, electronic control unit 5 and solenoid valves 12 of the slip control are located, may also be referred to as motor side, control-unit side and/or valve side of hydraulic block 1.

On an inner side of control-unit housing 15, which faces hydraulic block 1, cylindrical tube-shaped coil holders 21 project from roof 16 of control-unit housing 15, embrace valve domes 14 concentrically and have solenoid coils 22 of electromagnets 13 of solenoid valves 12.

Hydraulic block 1 has a brake master cylinder bore 23, in which a brake master cylinder piston (not shown) is displaceably accommodated. The brake master cylinder piston, which may also be referred to as rod piston or primary piston, is displaceable in the brake master cylinder bore with muscular energy via a pedal rod, using a foot brake pedal or a handbrake lever (not shown). For the design as a dual-circuit brake master cylinder, a second so-called floating piston or secondary piston may be disposed in brake master cylinder bore 23. Brake master cylinder bore 23 passes parallel to the two large sides of hydraulic block 1 and in a center between the two large sides, through hydraulic block 1. The brake master cylinder piston(s) may be supported, in a manner allowing axial displacement, directly in brake master cylinder bore 23 or indirectly in, e.g., a cylinder sleeve disposed in brake master cylinder bore 23.

In a narrow side of hydraulic block 1 adjoining the two large sides, which is denoted here as reservoir side 24, hydraulic block 1 according to the present invention has blind holes as reservoir connections 25 for a brake-fluid reservoir 26 disposed on reservoir side 24 of hydraulic block 1. At its bottom, brake-fluid reservoir 26 has connecting nipples 27 which, upon placement of brake-fluid reservoir 26 upon reservoir side 24 of hydraulic block 1, enter into reservoir connections 25 and are sealed there by O-rings, so that brake master cylinder bore 23 and power cylinder bore 6 are connected to brake-fluid reservoir 26.

Brake master cylinder bore 23 is located on a side of power cylinder bore 6 facing away from reservoir side 24, or, put another way, power cylinder bore 6 is located between reservoir side 24 of hydraulic block 1 and brake master cylinder bore 23. Viewed in a direction perpendicular to reservoir side 24, power cylinder bore 6 and brake master cylinder bore 23 intersect each other, whereas they actually do not intersect each other, but rather pass by one another at a distance.

In the large side opposite first side 8, hydraulic block 1 has blind holes—four in the exemplary embodiment—as brake-line connections 28, to which brake lines (not shown) leading to hydraulic wheel brakes (likewise not shown) are connectable. For example, the brake lines are connectable to brake-line connections 28 by threaded nipples that are able to be screwed into brake-line connections 28, or by press nipples that are able to be pressed into brake-line connections 28.

What is claimed is:

1. A hydraulic block for a hydraulic modulator of a vehicle hydraulic-power brake system, comprising:
an electronic control unit for a brake-pressure control, the control unit being disposed on a first side of the hydraulic block, having mountings for solenoid valves for the brake-pressure control, which are placed in the first side of the hydraulic block;
a power cylinder bore which passes through the hydraulic block from the first side to a side opposite the first side; and
an electric motor configured for electromechanical displacement of a power piston in the power cylinder bore, wherein the electric motor is mounted on the first side of the hydraulic block.

2. The hydraulic block as recited in claim 1, wherein the electronic control unit has a box-shaped control-unit housing whose open side faces the first side of the hydraulic block, and which covers the electric motor.

3. The hydraulic block as recited in claim 1, wherein the electronic control unit has an angle-of-rotation sensor for a rotor of the electric motor.

4. The hydraulic block as recited in claim 1, wherein in a reservoir side adjoining the first side, the hydraulic block has a reservoir connection for a brake-fluid reservoir, and on a side of the power cylinder bore facing away from the reservoir side, the hydraulic block has a brake master cylinder bore.
